(19) United States
(12) Patent Application Publication
(10) Pub. No.: US 2026/0301559 A1
(43) Pub. Date: Oct. 1, 2026

(54) POOL SYSTEM WITH GATEWAY FOR AIR-WATER COMMUNICATION

(71) Applicant: ZODIAC POOL CARE EUROPE, Belberaud (FR)

(72) Inventor: Benjamin Fontanili, Belberaud (FR)

(73) Assignee: ZODIAC POOL CARE EUROPE, Belberaud (FR)

(21) Appl. No.: 19/576,115

(22) Filed: Mar. 24, 2026

Related U.S. Application Data
(60) Provisional application No. 63/779,467, filed on Mar. 28, 2025.

(51) Int. Cl. G08C 17/00; E04H 4/16; F16M 13/02

(52) U.S. Cl. CPC G08C 17/00; E04H 4/1654; F16M 13/02

(57) ABSTRACT

A pool system includes a self-propelled pool cleaner and a communications gateway. The communications gateway may receive an air gateway communication signal from an external device and convert the air gateway communication signal to a water gateway communication signal. In some cases, the air gateway communication signal includes an RF signal, and the water gateway communication signal includes one or more of an RF signal, an optical signal, a vibration signal, and/or a sound signal. The communications gateway may provide the converted water gateway communication signal to the self-propelled pool cleaner.

### REFERENCE TO RELATED APPLICATION

This application claims the benefit of and priority to U.S. Provisional Patent Application No. 63/779,467, filed on Mar. 28, 2025, and entitled POOL SYSTEM WITH GATEWAY FOR AIR-WATER COMMUNICATION, the content of which is hereby incorporated by reference in its entirety.

### FIELD OF THE INVENTION

The invention relates to self-propelled pool cleaners for cleaning water-containing vessels such as swimming pools and spas, and more particularly to communication systems for such pool cleaners.

### BACKGROUND

Self-propelled pool cleaners capable of autonomous or semi-autonomous movement within swimming pools and spas currently exist. The most common of these devices are automatic swimming pool cleaners, which often are either hydraulic or robotic in type. Hydraulic cleaners vary water flow for movement, while robotic cleaners typically employ electric motors to cause motion. Hydraulic pool cleaners, furthermore, subdivide into “pressure-side” and “suction-side” cleaners, with pressure-side cleaners being fluidly connected to outputs of pumps of pool water circulation systems and suction-side cleaners being fluidly connected to inputs of such pumps.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various embodiments of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

According to certain embodiments, a pool system includes a self-propelled pool cleaner and a communications gateway configured to (i) receive an air gateway communication signal from an external device, (ii) convert the air gateway communication signal to a water gateway communication signal. The air gateway communication signal may include an RF signal, and the water gateway communication signal may include one or more of an RF signal, an optical signal, a vibration signal, and/or a sound signal. The communications gateway may further provide the converted water gateway communication signal to the self-propelled pool cleaner.

According to some embodiments, a pool system includes a self-propelled pool cleaner with a water gateway communication receiver system. The pool system also includes a communications gateway configured to (i) receive an RF signal from an application, the RF signal comprising at least one command for the self-propelled pool cleaner, and (ii) send the at least one command to the self-propelled pool cleaner via a water gateway communication signal.

In certain embodiments, a pool system includes a self-propelled pool cleaner and a communications gateway configured to (i) receive a WiFi signal and/or a LoRa signal from an external device, (ii) convert the WiFi signal and/or LoRa signal to a LiFi signal, and (iii) provide the converted LiFi signal to the self-propelled pool cleaner.

According to various embodiments, a pool system includes a self-propelled pool cleaner with a LiFi receiver system. The pool system also includes a communications gateway configured to (i) receive a WiFi signal from an application, the WiFi signal comprising at least one command for the self-propelled pool cleaner, and (ii) send the at least one command to the self-propelled pool cleaner via a LiFi signal.

According to certain embodiments, a pool system includes a self-propelled pool cleaner with a LiFi receiver system and a communications gateway. The communications gateway may receive a LoRa signal from an application, the LoRa signal having at least one command for the self-propelled pool cleaner, and may further send the at least one command to the self-propelled pool cleaner via a LiFi signal.

According to some embodiments, a pool system includes a communications gateway configured to receive an RF signal from an external device, the RF signal comprising at least one command for a self-propelled pool cleaner, and provide the at least one command to the self-propelled pool cleaner via a water gateway communication signal. In some cases, the communications gateway is at least one of: on or coupled with a docking station for the pool cleaner, installed on a skimmer, integrated into a pool wall, integrated into a remote control for the pool cleaner, integrated into a floating module configured to float within a pool or spa, and/or integrated into a support handle for the pool cleaner.

According to certain embodiments, a method of controlling a self-propelled pool cleaner includes receiving an RF signal from an external device, the RF signal comprising at least one command for the self-propelled pool cleaner. The method includes providing the at least one command to the self-propelled pool cleaner via a water gateway communication signal.

A non-transitory computer readable storage medium may include a plurality of instructions executable by one or more processors, which, when executed on the one or more processors, cause the one or more processors to perform actions including receiving an RF signal from an external device, the RF signal comprising at least one command for the self-propelled pool cleaner, and providing the at least one command to the self-propelled pool cleaner via a water gateway communication signal.

In some embodiments, a pool system includes a self-propelled pool cleaner and a communications gateway. The communications gateway may receive an RF signal from an external device, (ii) convert the RF signal to a water gateway communication signal, and provide the converted RF signal to the self-propelled pool cleaner.

In certain embodiments, a pool system includes a self-propelled pool cleaner with a receiver system. The pool system includes a communications gateway configured to (i) receive a WiFi signal from an application and/or external device, the WiFi signal comprising at least one command for the self-propelled pool cleaner, and (ii) send the at least one command to the self-propelled pool cleaner via a LiFi signal or LoRa signal.

In various embodiments, a method of controlling a self-propelled pool cleaner may include receiving a WiFi signal from an external device, the WiFi signal comprising at least one command for the self-propelled pool cleaner. The method may include providing the at least one command to the self-propelled pool cleaner via a LiFi signal or LoRa signal.

According to some embodiments, non-transitory computer readable storage medium may include a plurality of instructions executable by one or more processors, which, when executed on the one or more processors, cause the one or more processors to perform actions including receiving a WiFi signal from an external device, the WiFi signal comprising at least one command for the self-propelled pool cleaner, and providing the at least one command to the self-propelled pool cleaner via a LiFi signal or LoRa signal

Various implementations described in the present disclosure can include additional systems, methods, features, and advantages, which cannot necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The features and components of the following figures are illustrated to emphasize the general principles of the present disclosure. Corresponding features and components throughout the figures can be designated by matching reference characters for the sake of consistency and clarity.

FIG. 1 illustrates a pool system with a communication gateway according to embodiments.

FIG. 2 illustrates a pool system with a communication gateway according to embodiments.

FIG. 3 illustrates a pool system with a communication gateway according to embodiments.

FIG. 4 illustrates a pool system with a communication gateway according to embodiments.

### DETAILED DESCRIPTION

Described herein are systems and methods for providing improved communication with a pool cleaner.

In some embodiments, the systems and methods described herein include a communications gateway for air gateway communication and water gateway communication. In certain embodiments, the air gateway communication methods may include any radio frequency (RF) based communication, such as but not limited to WiFi, LoRa, Bluetooth, Zigbee, cellular, etc. In various embodiments, the water communication methods may include RF, optical, vibration, sound, etc. As a non-limiting example, the water gateway communication methods may include ultrasonic communication, LiFi communication, combinations thereof, and/or as otherwise desired.

Some pool cleaners, particularly but not limited to battery-powered pool cleaners, may be configured for a particular type of wireless communication. “Wireless communication” as used herein refers to communication between two (or more) devices that does not require a wired connection, and is not intended to be limited to RF communication. As non-limiting examples, a pool cleaner may include a LiFi receiver system for water gateway communication. Other water gateway communication techniques may be utilized as desired and as mentioned previously. Such systems conventionally require a specific remote (e.g., a LiFi remote) to communicate with such pool cleaners via a water gateway communication technique. In such embodiments, a user must physically handle the remote to send a command to the pool cleaner, and in the absence of manually handling the remote, commands cannot be sent to the pool cleaner.

In certain embodiments, the systems and methods described herein provide a communications gateway for linking the LiFi remote (or other remote for water gateway communication) to a user device (e.g., a user device running an application) or other device via air gateway communication. While reference may be used herein to a “LiFi” remote, the description is equally applicable to other devices for other types of water gateway communication, and reference to the LiFi remote should not be considered limiting. In such embodiments, the communications gateway may convert a first type of wireless signal from the user device (e.g., a RF signal such as but not limited to WiFi, LoRa, Bluetooth, Zigbee, cellular, etc.) to a second type of signal (e.g., another RF signal, an optical signal (such as but not limited to LiFi), a vibration signal, a sound signal, etc.) used by the LiFi remote to communicate with the pool cleaner. As a non-limiting example, the first type of wireless signal may be WiFi, and the second type of signal may be LiFi or LoRa. Other combinations of types of signals may be utilized as desired. With the systems and methods described herein, the communications gateway may send commands to the remote (e.g., LiFi commands) and/or the pool cleaner, i.e., as a type of signal different from that received by the communications gateway. In some embodiments, the communications gateway described herein may facilitate signals reaching the pool cleaner through water. As non-limiting examples, the communications gateway may reduce the distance that the signal has to travel, particularly, but not limited to, through water.

The communications gateway may be provided at various locations relative to the pool system as desired. In some embodiments, the communications gateway may be integrated into and/or connectable to the LiFi remote. Additionally, or alternatively, the communications gateway may be integrated into and/or connectable to a floating module that is buoyant and/or otherwise configured to float within a swimming pool or spa. Additionally, or alternatively, the communications gateway may be integrated into and/or connectable to a docking station for the pool cleaner. Additionally, or alternatively, the communications gateway may be integrated into and/or connectable to a support handle for the pool cleaner. Additionally, or alternatively, the communications gateway may be integrated into and/or connectable to a surface of the pool or spa, such as but not limited to a pool wall. Additionally, or alternatively, the communications gateway may be integrated into and/or connectable to a skimmer of the pool system. Additionally, or alternatively, the communications gateway may be integrated into and/or connectable to the pool cleaner. Various other locations or combinations of locations may be utilized as desired.

Compared to traditional approaches, the systems and methods provide improved communication with a pool cleaner. Various other benefits and advantages may be realized with the systems, devices, and methods provided herein, and the aforementioned advantages should not be considered limiting.

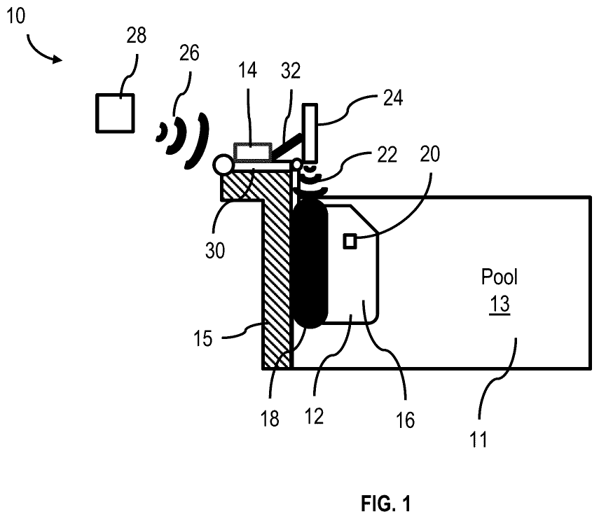

FIGS. 1-4 illustrate a pool system 10 with a pool or spa 11 (hereinafter “pool 11”), a pool cleaner 12, and a communications gateway 14 according to embodiments.

The pool 11 may have various shapes, sizes, features, and configurations as desired and generally may contain a volume of water 13. In some embodiments, the pool 11 includes one or more pool walls 15 and a floor, and optionally includes one or more features such as steps, a beach, a bench, combinations thereof, and/or other features as desired.

The pool cleaner 12 may be self-propelled and may be various types of cleaners capable of autonomous or semi-autonomous movement within the pool 11. In certain embodiments, the pool cleaner 12 may be a robotic cleaner using electrical power for movement and cleaning. Additionally, or alternatively, the pool cleaner 12 may be a hydraulic cleaner utilizing water flow and/or water jets for movement.

The pool cleaner 12 may generally include a body or housing 16 with one or more inlets and one or more outlets. One or more motive elements 18 (e.g., wheels, tracks, rollers, propellers, feet, combinations thereof, etc.) may allow or enable movement of the pool cleaner 12 within the pool 11. In some embodiments, the pool cleaner 12 may include one or more cleaning devices (including but not limited to one or more brush assemblies). A motor, a pump, a filter, a control system (processor and/or memory), and/or various other features or combinations of features may be provided on or within the pool cleaner 12 as desired. As a non-limiting example, the pool cleaner 12 may include a filter, and debris-laden water may enter the filter (e.g., from the one or more inlets), with the filter stopping or capturing at least some of the debris before allowing filtered water to exit (e.g., through the one or more outlets). In certain embodiments, the pool cleaner 12 includes an on-board power source, such as but not limited to one or more on-board batteries. Non-limiting examples of pool cleaners 12 may include those described in U.S. Pat. Nos. 10,316,534, 9,488,154, 8,578,538, and/or U.S. Patent Publication No. 2014/0303810, all of which are hereby incorporated by reference in their entireties.

In various embodiments, and as illustrated in FIGS. 1-4, the pool cleaner 12 may include a water communication system 20 for sending and/or receiving water gateway communication signals 22 and/or determining various control operations from the water gateway communication signals 22. In one non-limiting example, the water gateway communication signals 22 may be LiFi signals; however, in other embodiments, the water gateway communication signals may be other types of signals such as but not limited to RF signals, other optical signals, vibration signals, sound signals, combinations thereof, and/or as otherwise desired.

The water gateway communication signals 22 received by the pool cleaner 12 may be obtained when the pool cleaner 12 is out of the water 13 of the pool 11, while the pool cleaner 12 is at a waterline of the pool 11, and/or while the pool cleaner is submerged in the pool 11. Similarly, water gateway communication signals 22 sent by the pool cleaner 12 may be sent while the pool cleaner 12 is out of the water 13 of the pool 11, while the pool cleaner 12 is at a waterline of the pool 11, and/or while the pool cleaner is submerged in the pool 11.

In certain examples, the water gateway communication signals 22 provided to the pool cleaner 12 may provide information to the pool cleaner 12 (e.g., sensor data from an external sensor, a scheduled use, combinations thereof, and/or as otherwise desired) and/or provide a command to the pool cleaner 12 (e.g., initiate a cleaning cycle, modify a cleaning cycle, stop a cleaning cycle, climb to a waterline, navigate to a docking station, combinations thereof, and/or as otherwise desired). Water gateway communication signals 22 from the pool cleaner 12 may include various information about the pool cleaner 12 itself and/or obtained by the pool cleaner 12. As non-limiting examples, information from the pool cleaner 12 provided via the water gateway communication signals 22 may include data from one or more onboard sensors, a battery status, a filter status, cleaning cycle information, commands from a remote device (e.g., a user), combinations thereof, and/or other information as desired.

In some embodiments, the pool system 10 optionally includes a water gateway communication remote 24 for receiving and/or sending the water gateway communication signals 22 with the pool cleaner 12. In one non-limiting example, the water gateway communication remote 24 is a LiFi remote. However, in other embodiments, the remote 24 may be configured for other water gateway communication signals as desired. In various embodiments, the water gateway communication remote 24 optionally includes various human machine interface features (e.g., buttons, knobs, a display, keys, slides, combinations thereof, and/or as otherwise desired) such that the water gateway communication remote 24 may receive user input directly on the water gateway communication remote 24.

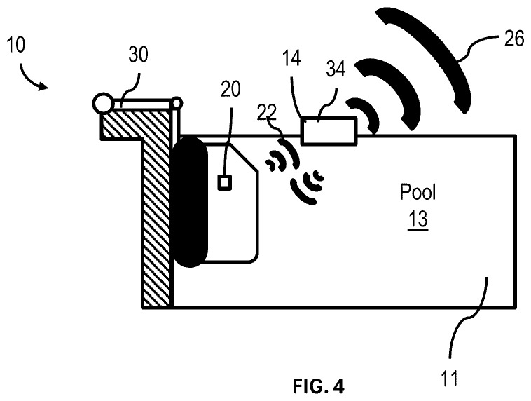

In various embodiments, and as previously discussed, the pool system 10 includes the communications gateway 14. While a single communications gateway 14 is illustrated in FIGS. 1-4, in other embodiments, any number of communications gateways 14 may be utilized as desired. In some embodiments, the communications gateway 14 may be a separate device or system that communicates directly or indirectly (e.g., via remote 24) with the pool cleaner 12 (see, e.g., FIGS. 1, 2, and 4). In other embodiments, the communications gateway 14 may be integrated with and/or a component of another device or vice versa. As non-limiting examples, FIG. 3 illustrates the communications gateway 14 integrated with the remote 24, and FIG. 4 illustrates the communications gateway 14 integrated with a floating module 34. Other arrangements for the communications gateway 14 may be utilized as desired.

The communications gateway 14 generally may receive a first type of wireless signal 26 from a user device 28 (and/or other remote system as desired) via an air gateway communication technique including at least one command and/or information for the pool cleaner 12. The first type of wireless signal 26 may be various types of RF signals as desired, such as but not limited to WiFi, LoRa, Bluetooth, Zigbee, cellular, combinations thereof, and/or other RF signals as desired. In such embodiments, the user device 28 may be various devices capable of providing such RF communications. As non-limiting examples, the user device 28 may be a phone, tablet, computer or computing system, combinations thereof, and/or as otherwise desired. In some embodiments, the user device 28 may be adapted to run an application, and the user device 28 may send information via the RF signal 26 based on input received via the application running on the user device 28.

The communications gateway 14, upon and/or based on receipt of the RF signal 26, may send the at least one command and/or information as a second type of wireless signal different from the first type of wireless signal as the water gateway communication signal. The second type of wireless signal may be various types of signals as desired, such as but not limited to RF signals, optical signals, vibration signals, sound signals, combinations thereof, and/or as otherwise desired.

In non-limiting examples, the first type of wireless signal 26 may be the RF signal (such as but not limited to a WiFi signal and/or a LoRa signal), and the second type of wireless signal is a LiFi signal 22. As another non-limiting example, the first type of wireless signal 26 may be WiFi, and the second type of wireless signal may be LiFi or LoRa. Other combinations of types of signals may be utilized as desired. Reference herein to WiFi, LoRa, and/or LiFi as the first type of wireless signal and/or the second type of wireless signal should not be considered limiting and instead is for illustrative purposes. The following description is equally applicable when the first type of wireless signal and second type of wireless signal are different types of wireless signals.

In certain embodiments, the communications gateway 14 may convert the first type of wireless signal 26 to the second type of wireless signal. As non-limiting examples, the communications gateway 14 may convert the RF signal as the first type of wireless signal 26 for the air gateway communication to the LiFi signal (or other water gateway communication signal) as the second type of wireless signal for the water gateway communication.

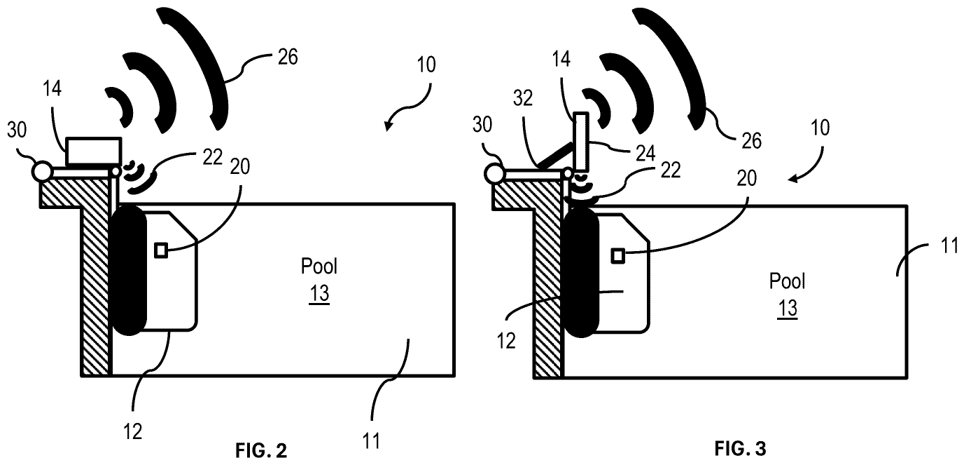

In some embodiments, and as illustrated in FIGS. 1 and 3, the water gateway communication signal 22 may be provided to the water gateway communication remote 24 such that the information is provided to the pool cleaner 12 via the water gateway communication remote 24. In other embodiments, and as illustrated in FIGS. 2-4, the water gateway communication signal 22 may be provided directly to the pool cleaner 12 from the communications gateway 14. In various embodiments, the communications gateway 14 may improve communications with the pool cleaner, allowing for a command and/or other information from a user at a remote location and/or to be provided wirelessly via RF signals (e.g., WiFi and/or LoRa) (e.g., in a form that the pool cleaner 12 is not configured to receive or that is not capable of reaching the pool cleaner 12 through the water) and provided to the pool cleaner 12 in a form (e.g., LiFi) that the pool cleaner 12 is adapted to receive and/or capable of reaching the pool cleaner 12 through the water.

In a similar manner, the communications gateway 14 may receive the water gateway communication signal from the pool cleaner 12 and convert the water gateway communication signal to an RF signal (e.g., WiFi signal and/or a LoRa signal) (and/or otherwise provide the information from the water gateway communication signal to the user device 28 via the RF signal).

In some embodiments, the communications gateway 14 optionally includes a processing unit and/or memory device. In such embodiments, the processing unit may be any suitable processing device or combination of devices including but not limited to one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units, and/or a combination thereof. The one or more memory devices may be any machine-readable medium that can be accessed by the processor, including but not limited to any type of long term, short term, volatile, nonvolatile, or other storage medium, and is not to be limited to any particular type of memory or number of memories, or type of media upon which memory is stored. Moreover, as disclosed herein, the term “storage medium,” “storage” or “memory” can represent one or more memories for storing data, including read only memory (ROM), random access memory (RAM), magnetic RAM, core memory, magnetic disk storage mediums, optical storage mediums, flash memory devices, and/or other machine readable mediums for storing information. The term “machine-readable medium” includes, but is not limited to, portable or fixed storage devices, optical storage devices, wireless channels, and/or various other storage mediums capable of storing that contain or carry instruction(s) and/or data.

The communications gateway 14 may be provided at various locations within the pool system 10 as desired. Illustrative examples are discussed in detail below and with reference to FIGS. 1-4, but these examples should not be considered limiting, and other locations may be utilized as desired.

In some embodiments, and as illustrated in FIG. 1, the communications gateway 14 may be integrated into and/or connected to a docking station 30 for the pool cleaner 12. In various embodiments, the docking station 30 may be adapted to support the pool cleaner 12 within the pool 11 or outside of the pool 11 as desired. Optionally, at least a portion of the docking station 30 may be submergible within the pool 11, although it need not be in other embodiments.

The communications gateway 14 may be provided on various components or portions of the docking station 30 as desired, such as but not limited to a handle of the docking station 30, a support platform of the docking station 30, combinations thereof, and/or as otherwise desired. In some embodiments, the communications gateway 14 is optionally provided on a portion of the docking station 30 above the waterline of the pool 11, although it need not be in other embodiments. In other embodiments, the communications gateway 14 may be provided at another location remote from the docking station 30.

Optionally, and as illustrated in FIGS. 1 and 2, the docking station 30 may further include a holder 32 for selectively holding the water gateway communication remote 24. In some embodiments, the holder 32 may position the water gateway communication remote 24 at a predetermined orientation or configuration relative to the pool cleaner 12, relative to the pool 11, and/or relative to the communications gateway 14, although it need not in other embodiments.

The communications gateway 14 on the docking station 30 may convert requests and/or commands received by an application running on the user device 28 (and provided to the communications gateway 14 via the air communication signal, e.g., an RF signal such as but not limited to WiFi or LoRa) into a water gateway communication signal that is provided to the pool cleaner 12 using the water gateway communication remote 24. Additionally, or alternatively, the communications gateway 14 on the docking station 30 may convert and directly communicate the water gateway communication signal 22 to the pool cleaner 12. Conversely, the communications gateway 14 may convert Water gateway communication signals 22 from the pool cleaner 12 into RF signals that are provided to the user device 28.

While FIG. 1 illustrates the docking station 30 with a separate communications gateway 14 and water gateway communication remote 24, in other embodiments, the docking station 30 may have other configurations incorporating the communications gateway 14.

As a non-limiting example, and as illustrated in FIG. 2, the docking station 30 optionally includes only the communications gateway 14 without the water gateway communication remote 24. In this example, the communications gateway 14 may receive (or send) the RF signal with the user device 28 and may directly provide the water gateway communication signal 22 to the pool cleaner 12 and/or receive the water gateway communication signal 22 from the pool cleaner 12.

As a further non-limiting example, as illustrated in FIG. 3, the communications gateway 14 may be integrated into and/or connected to the water gateway communication remote 24. In such embodiments, the docking station 30 optionally includes the holder 32, although it need not in other embodiments. In embodiments where the communications gateway 14 is integrated into and/or connected to the water gateway communication remote 24, the modified water gateway communication remote 24 may be adapted to receive and convert the RF signal from the user device 28 to the water gateway communication signal (via the communications gateway 14) and/or may receive user input directly on the water gateway communication remote 24 via a human machine interface. Conversely, the modified water gateway communication remote 24 with the communications gateway 14 may convert Water gateway communication signals 22 from the pool cleaner 12 into RF signals that are provided to the user device 28.

Additionally, or alternatively, to the docking station 30, the communications gateway 14 may be provided at other locations as desired. As a non-limiting example, FIG. 4 illustrates the communications gateway 14 integrated into and/or connected to a floating module 34 which is buoyant and/or adapted to float within the pool 11. In such embodiments, the communications gateway 14 on the floating module 34 may receive the RF signal from the user device 28 and the communications gateway 14 may convert and communicate the water gateway communication signal 22 directly with the pool cleaner 12. Conversely, the communications gateway 14 may receive Water gateway communication signals 22 from the pool cleaner 12 and convert the Water gateway communication signals 22 into RF signals that are provided to the user device 28.

In another non-limiting example, the communications gateway 14 may be integrated into and/or connected to the pool cleaner 12 itself.

In yet another non-limiting examples, the communications gateway may be integrated into and/or connected to a pool wall 15 of the pool 11.

In a further non-limiting example, the communications gateway 14 may be integrated into and/or connected to other equipment of the pool system 10. As a non-limiting example, the communications gateway 14 may be integrated into and/or connected to a skimmer of the pool system 10.

As mentioned, other locations of the communications gateway 14 may be utilized as desired, and the aforementioned examples should not be considered limiting.

Exemplary concepts or combinations of features of the invention may include:
A. A pool system comprising:
   i. a self-propelled pool cleaner; and
   ii. a communications gateway configured to (i) receive an air gateway communication signal from an external device, (ii) convert the air gateway communication signal to a water gateway communication signal, wherein the air gateway communication signal comprises an RF signal, and wherein the water gateway communication signal comprises one or more of an RF signal, an optical signal, a vibration signal, and/or a sound signal, and (iii) provide the converted water gateway communication signal to the self-propelled pool cleaner.
B. A pool system comprising:
   i. a self-propelled pool cleaner with a water gateway communication receiver system; and
   ii. a communications gateway configured to (i) receive an RF signal from an application, the RF signal comprising at least one command for the self-propelled pool cleaner, and (ii) send the at least one command to the self-propelled pool cleaner via a water gateway communication signal.
C. The pool system, method, and/or instructions of any preceding or subsequent statements or combination of statements, wherein the RF signal comprises WiFi, LoRa, Bluetooth, Zigbee, and/or cellular.
D. The pool system, method, and/or instructions of any preceding or subsequent statements or combination of statements, wherein the RF signal comprises WiFi and/or LoRa.
E. The pool system, method, and/or instructions of any preceding or subsequent statements or combination of statements, wherein the water gateway communication signal comprises one or more of an RF signal, an optical signal, a vibration signal, and/or a sound signal.
F. A pool system comprising:
   i. a self-propelled pool cleaner; and
   ii. a communications gateway configured to (i) receive a WiFi signal and/or a LoRa signal from an external device, (ii) convert the WiFi signal and/or LoRa signal to a LiFi signal, and (iii) provide the converted LiFi signal to the self-propelled pool cleaner.
G. A pool system comprising:
   i. a self-propelled pool cleaner with a LiFi receiver system; and
   ii. a communications gateway configured to (i) receive a WiFi signal from an application, the WiFi signal comprising at least one command for the self-propelled pool cleaner, and (ii) send the at least one command to the self-propelled pool cleaner via a LiFi signal.
H. A pool system comprising:
   i. a self-propelled pool cleaner with a LiFi receiver system; and
   ii. a communications gateway configured to (i) receive a LoRa signal from an application, the LoRa signal comprising at least one command for the self-propelled pool cleaner, and (ii) send the at least one command to the self-propelled pool cleaner via a LiFi signal.
I. A pool system comprising a communications gateway configured to:
   i. receive an RF signal from an external device, the RF signal comprising at least one command for a self-propelled pool cleaner; and
   ii. provide the at least one command to the self-propelled pool cleaner via a water gateway communication signal,
   iii. wherein the communications gateway is at least one of:
      a. on or coupled with a docking station for the pool cleaner;
      b. installed on a skimmer;
      c. integrated into a pool wall;
      d. integrated into a remote control for the pool cleaner;
      e. integrated into a floating module configured to float within a pool or spa;
      f. integrated into a support handle for the pool cleaner.
J. A method of controlling a self-propelled pool cleaner, the method comprising:
   i. receiving an RF signal from an external device, the RF signal comprising at least one command for the self-propelled pool cleaner; and
   ii. providing the at least one command to the self-propelled pool cleaner via a water gateway communication signal.
K. A non-transitory computer readable storage medium comprising a plurality of instructions executable by one or more processors, which, when executed on the one or more processors, cause the one or more processors to perform actions including:
   i. receiving an RF signal from an external device, the RF signal comprising at least one command for the self-propelled pool cleaner; and
   ii. providing the at least one command to the self-propelled pool cleaner via a water gateway communication signal.
L. A pool system comprising:
   i. a self-propelled pool cleaner; and
   ii. a communications gateway configured to (i) receive an RF signal from an external device, (ii) convert the RF signal to a water gateway communication signal, and (iii) provide the converted RF signal to the self-propelled pool cleaner.
M. A pool system comprising:
   i. a self-propelled pool cleaner with a receiver system; and
   ii. a communications gateway configured to (i) receive a WiFi signal from an application and/or external device, the WiFi signal comprising at least one command for the self-propelled pool cleaner, and (ii) send the at least one command to the self-propelled pool cleaner via a LiFi signal or LoRa signal.
N. A method of controlling a self-propelled pool cleaner, the method comprising:
   i. receiving a WiFi signal from an external device, the WiFi signal comprising at least one command for the self-propelled pool cleaner; and
   ii. providing the at least one command to the self-propelled pool cleaner via a LiFi signal or LoRa signal.
O. A non-transitory computer readable storage medium comprising a plurality of instructions executable by one or more processors, which, when executed on the one or more processors, cause the one or more processors to perform actions including:
   i. receiving a WiFi signal from an external device, the WiFi signal comprising at least one command for the self-propelled pool cleaner; and
   ii. providing the at least one command to the self-propelled pool cleaner via a LiFi signal or LoRa signal.

These examples are not intended to be mutually exclusive, exhaustive, or restrictive in any way, and the invention is not limited to these example embodiments but rather encompasses all possible modifications and variations within the scope of any claims ultimately drafted and issued in connection with the invention (and their equivalents). For avoidance of doubt, any combination of features not physically impossible or expressly identified as non-combinable herein may be within the scope of the invention. Further, although applicant has described devices and techniques for use principally with pool cleaners, persons skilled in the relevant field will recognize that the present invention conceivably could be employed in connection with other objects and in other manners. Finally, references to “pools” and “swimming pools” herein may also refer to spas or other water containing vessels used for recreation, training, or therapy and for which cleaning of debris is needed or desired.

As used herein, the meaning of “a,” “an,” and “the” includes singular and plural references unless the context clearly dictates otherwise.

The subject matter of embodiments of the present disclosure is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described. A zero angle refers to an angle of 0° or 180°. Directional references such as “up,” “down,” “top,” “bottom,” “left,” “right,” “vertical,” “horizontal,” “lateral,” “longitudinal,” “front,” and “back,” among others, are intended to refer to the orientation as illustrated and described in the figure (or figures) to which the components and directions are referencing.

The terms “comprising,” “having,” “including,” and “containing” are to be construed as open-ended terms (i.e., meaning “including, but not limited to,”) unless otherwise noted. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

The above-described aspects are merely possible examples of implementations, merely set forth for a clear understanding of the principles of the present disclosure. Many variations and modifications can be made to the above-described embodiment(s) without departing substantially from the spirit and principles of the present disclosure. All such modifications and variations are intended to be included herein within the scope of the present disclosure, and all possible claims to individual aspects or combinations of elements or steps are intended to be supported by the present disclosure. Moreover, although specific terms are employed herein, as well as in the claims that follow, they are used only in a generic and descriptive sense, and not for the purposes of limiting the described embodiments, nor the claims that follow.

That which is claimed:

1. A pool system comprising:
a self-propelled pool cleaner; and
a communications gateway configured to (i) receive an air gateway communication signal from an external device, (ii) convert the air gateway communication signal to a water gateway communication signal, wherein the air gateway communication signal comprises an RF signal, and wherein the water gateway communication signal comprises one or more of an RF signal, an optical signal, a vibration signal, and/or a sound signal, and (iii) provide the converted water gateway communication signal to the self-propelled pool cleaner.

2. The pool system of claim 1, wherein the air gateway communication signal comprises at least one command for the self-propelled pool cleaner.

3. The pool system of claim 1, wherein the RF signal of the air gateway communication signal comprises WiFi, LoRa, Bluetooth, Zigbee, and/or cellular.

4. The pool system of claim 1, wherein the RF signal comprises WiFi and/or LoRa.

5. The pool system of claim 1, wherein the water gateway communication signal comprises one or more of an RF signal, an optical signal, a vibration signal, and/or a sound signal.

6. The pool system of claim 1, wherein the water gateway communication signal comprises LiFi.

7. The pool system of claim 1, further comprising a docking station for the pool cleaner, wherein the communications gateway is on or coupled with the docking station.

8. The pool system of claim 1, further comprising a remote, wherein the communications gateway is separate from the remote.

9. The pool system of claim 1, further comprising a remote, wherein the communications gateway is integrated with the remote.

10. The pool system of claim 1, wherein the communications gateway is integrated into a floating module configured to float within a pool or spa.

11. A method of controlling a self-propelled pool cleaner, the method comprising:
receiving an RF signal from an external device, the RF signal comprising at least one command for the self-propelled pool cleaner; and
providing the at least one command to the self-propelled pool cleaner via a water gateway communication signal.

12. The method of claim 11, wherein the RF signal comprises WiFi, LoRa, Bluetooth, Zigbee, and/or cellular.

13. The method of claim 11, wherein the RF signal comprises WiFi and/or LoRa.

14. The method of claim 11, wherein the water gateway communication signal comprises one or more of an RF signal, an optical signal, a vibration signal, and/or a sound signal.

15. The method of claim 11, wherein the water gateway communication signal comprises LiFi.

16. A non-transitory computer readable storage medium comprising a plurality of instructions executable by one or more processors, which, when executed on the one or more processors, cause the one or more processors to perform actions including:
receiving an RF signal from an external device, the RF signal comprising at least one command for the self-propelled pool cleaner; and
providing the at least one command to the self-propelled pool cleaner via a water gateway communication signal.

17. The non-transitory computer readable storage medium of claim 16, wherein the RF signal comprises WiFi, LoRa, Bluetooth, Zigbee, and/or cellular.

18. The non-transitory computer readable storage medium of claim 16, wherein the RF signal comprises WiFi and/or LoRa.

19. The non-transitory computer readable storage medium of claim 16, wherein the water gateway communication signal comprises one or more of an RF signal, an optical signal, a vibration signal, and/or a sound signal.

20. The non-transitory computer readable storage medium of claim 16, wherein the water gateway communication signal comprises LiFi.
